(19) United States
(12) Patent Application Publication
(10) Pub. No.: US 2003/0029379 A1
(43) Pub. Date: Feb. 13, 2003

(54) Electrostatic coating device and electrostatic coating method

(75) Inventors: Toru Onogawa, Shizuoka-ken (JP); Manabu Hashigaya, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/190,836

(22) Filed: Jul. 9, 2002

(30) Foreign Application Priority Data
Jul. 11, 2001 (JP) 2001-211120
Feb. 5, 2002 (JP) 2002-27712

(51) Int. Cl. B05C 5/02

(52) U.S. Cl. 118/621

(57) ABSTRACT

An electrostatic coating device and an electrostatic coating method are provided which can expel, in a form of drops having high monodispersability, a coating liquid which is highly viscous. The electrostatic coating device includes a coating liquid chamber storing a coating liquid in an interior of the coating liquid chamber; a voltage applying portion applying a voltage, which is positive or negative with respect to an object-to-be-coated onto which the coating liquid is to be coated, to the coating liquid in the coating liquid chamber; and a nozzle expelling, in drop form and toward the object-to-be-coated, the coating liquid to which the voltage has been applied by the voltage applying portion.

### BACKGROUND OF THE INVENTION

1. Field of the Invention

The present invention relates to an electrostatic coating device and an electrostatic coating method, and in particular, to an electrostatic coating device and an electrostatic coating method which are suitably used in particular for making PS plates matte.

2. Description of the Related Art

In recent years, ink jet printers, which form printed images by ink jets, have come to be widely used as printers for computers.

An ink jet printer is usually equipped with an ink jet head having many nozzles which expel ink in the form of drops, and ink chambers which are provided in correspondence with the respective nozzles and in which ink is stored. Each ink chamber has a pressure generating member which generates the pressure for expelling the ink from the nozzle, and a piezo-electric element which drives the pressure generating member.

The particle size distribution of the ink drops of the ink jet printer is relatively close to monodisperse. Thus, it would be thought that, when an ink jet printer is used to matte a PS plate by expelling, in the form of drops, a matting liquid instead of ink, a matte of a uniform size would be able to be obtained.

However, when a PS plate is made matte by using an ink jet printer, the width of the ink jet must be made to be about the same as the width of the PS plate so that the entire width of the PS plate can be covered by the ink jet head. Further, the interval between the nozzles at the ink jet head must be set to about several 100 μm so that the dots formed by the matting liquid expelled from the nozzles overlap one another. Here, if the width of the PS plate is 1 m and the interval between the nozzles is 500 μm, there are 2000 nozzles at the ink jet head.

Accordingly, if the pressure generating members and the piezo-electric elements are provided in a one-to-one correspondence with the nozzles, there is the need to provide 2000 pressure generating members and 2000 piezo-electric elements. Thus, the number of structural parts of the ink jet head becomes large, and the manufacturing costs drastically increase. This is also impractical from the standpoint of complexity of the control of the expulsion of the ink.

Moreover, the matting liquid used in making the PS plate matte is highly viscous, and, at the ink jet head, there are difficulties in expelling highly viscous inks.

### SUMMARY OF THE INVENTION

An object of the present invention is to provide an electrostatic coating (depositing) device and an electrostatic coating (depositing) method whose structures are simple and which can expel, in drops having good monodispersability, a highly-viscous coating liquid such as a matting liquid, so as to be able to be suitably used for matting PS plates.

A first aspect of the present invention relates to an electrostatic coating device comprising: a coating liquid chamber storing a coating liquid in an interior of the coating liquid chamber; a voltage applying portion applying a voltage, which is one of positive and negative with respect to an object-to-be-coated onto which the coating liquid is to be coated, to the coating liquid in the coating liquid chamber; and a nozzle expelling, in drop form and toward the object-to-be-coated, the coating liquid to which the voltage has been applied by the voltage applying portion.

In this electrostatic coating device, the coating liquid chamber is filled with the coating liquid. When a voltage, which is positive or negative with respect to the object-to-be-coated, is applied to the coating liquid by the voltage applying portion, charged (electrified) drops of the coating liquid are discharged from the opening portions of the nozzles toward the object-to-be-coated at uniform intervals. Due to the Coulomb force, the charged drops fly toward the object-to-be-coated and adhere thereto.

In accordance with the electrostatic coating device, even if the coating liquid is a highly-viscous liquid having a viscosity of 100 mPa·s or more such as a matting liquid used in making a PS plate matte, the matting liquid can efficiently be made into fine particles, and charged drops having a uniform particle size distribution close to monodisperse can be obtained. Accordingly, if the electrostatic coating device is used in making a PS plate matte, a matte, which has good uniformity of diameter and height and whose height is large with respect to the diameter thereof, can be adhered at a high density.

The coating liquid which can be coated by the electrostatic coating device is not particularly limited provided that it can be coated onto an object-to-be-coated which will be described later. The coating liquid encompasses, for example, liquids from liquids having a relatively low viscosity such as solvent type coating materials and emulsion type coating materials used in electrostatic coating, to even liquids of a viscosity as high as several 100 m Pa·s such as matting liquids and high-solid type coating materials.

Examples of the object-to-be-coated are sheet-shaped or film-shaped articles onto which the coating liquid can be electrostatically coated. Specific examples include, in addition to PS plates, electrically conductive sheet materials such as thin aluminum plates, thin steel plates and the like, and insulative sheet materials such as plastic sheets, plastic films, paper, various types of laminated paper, and the like.

The object-to-be-coated may be in the form of a strip, or may be in the form of a sheet which has been cut to a specific size.

The coating liquid chamber and the nozzle may be formed from an insulative material such as plastic or an insulative ceramic or the like. If the coating liquid chamber and the nozzle are formed from an electrically conductive material such as aluminum, an aluminum alloy, stainless steel, an electrically conductive ceramic, or the like, voltage can be applied to the coating liquid in the interior merely by connecting the coating liquid chamber and the nozzle to a voltage generating device which will be described later.

Examples of the nozzle are a tubular nozzle and a nozzle hole which pass through a wall surface of the coating liquid chamber.

Hereinafter, the coating liquid chamber and the nozzle together may be referred to as the “coating head”.

The inner diameter of the nozzle is preferably in a range of 10 to 100 μm. However, the inner diameter may be less than or equal to 10 μm or may be greater than or equal to 100 μm, depending on the particle size of the charged drop which is to be expelled and the voltage applied by the voltage applying portion.

The interval between the nozzles can be determined in accordance with whether the coating liquid is to be adhered in dot-forms on the object-to-be-coated, or whether the coating liquid is to be adhered uniformly onto the entire surface of the object-to-be-coated. For example, when the coating liquid is to be adhered in dot-forms as in the case of matting a PS plate, the charged drops of the coating liquid do not overlap on the surface of the object-to-be-coated. Accordingly, it is preferable that the minimum interval between the nozzles is about 50 μm so that the charged drops do not coalesce. However, when the particle size of the charged drops which are expelled from the nozzles are small, the interval between the nozzles may be less than 50 μm.

Further, the interval between the distal end of the nozzle and the object-to-be-coated can be determined, from the relationship with the magnitude of the voltage applied by the voltage applying portion which will be described later, such that the number of charged drops expelled from the nozzle per unit time falls within a desired range. However, the interval between the distal end of the nozzle and the object-to-be-coated is preferably set in a range of 1 mm to 500 mm.

The nozzle may be directed downward, upward, or sideways.

When the coating liquid chamber and the nozzle are formed from an electrically conductive material, a voltage generating device, which is connected to at least one of the coating liquid chamber and the nozzle, can be used as the voltage applying portion. Any of various types of high voltage DC generating circuits, high voltage AC generating circuits, high voltage rectangular wave current generating circuits, high voltage trapezoid wave generating circuits, and the like may be used as the voltage generating device.

When the coating liquid chamber and the nozzle are formed from an insulative material, a voltage generating device, which is formed by a voltage applying electrode provided within the coating liquid chamber and a voltage generating device applying voltage to the voltage applying electrode, can be used as the voltage applying portion. Examples of the voltage applying electrode are electrodes having any type of configuration such as plate-shaped, lattice-shaped, linear, spiral, rod-shaped, or the like. The voltage applying electrode can be formed from any of various types of metal materials and carbon materials. The voltage generating device is as was described previously.

The inner wall surfaces of the coating liquid chamber may be lined with an electrically conductive material, and this electrically conductive lining may be used as the voltage applying electrode.

The magnitude of the voltage applied at the voltage applying portion can be determined from the relationship with the distance from the distal end of the nozzle to the object-to-be-coated, such that the number of charged drops expelled from the nozzle in one second falls within a desired range. However, usually, the magnitude of the voltage is within a range of 1 to 25 kV, and preferably a range of 3 to 10 kV.

The voltage applying portion preferably applies direct current, but may apply a sine wave such as ordinary commercial alternating current, or may apply alternating current having any type of waveform such as a rectangular wave, a trapezoidal wave, or the like. When alternating current is applied, the particle size of the charged drop expelled from the nozzle can be controlled by controlling the waveform of the alternating current.

When voltage is applied by the voltage applying portion, voltage of an opposite polarity may be applied to the object-to-be-coated, or the object-to-be-coated may be grounded. Further, when the object-to-be-coated is a non-conductive sheet material, a ground electrode may be provided between the object-to-be-coated and the nozzle, or adjacent to the surface of the object-to-be-coated at the side opposite the side where the coating liquid is to be adhered.

The invention of the second aspect, which is in accordance with the first aspect, relates to an electrostatic coating device in which the nozzle is a plurality of nozzles.

This electrostatic coating device is an example in which, in the electrostatic coating device of the first aspect, a plurality of nozzles are provided.

An example of this electrostatic coating device is an electrostatic coating device equipped with a coating liquid chamber having a nozzle plate which is a plate-shaped member at which many nozzles are formed. The nozzles may be provided at the entire surface of the nozzle plate, or may be disposed in one row at the nozzle plate.

In an electrostatic coating device equipped with a coating head having the above-described nozzle plate, if the width of the nozzle plate is formed so as to correspond to the width of the object-to-be-coated, the coating liquid can be coated on the entire surface of the object-to-be-coated by fixing the coating head and feeding the object-to-be-coated at a constant speed. Or, a plurality of coating heads can be set in a row so as to correspond to the width of the object-to-be-coated. Accordingly, the electrostatic coating device having the coating head is extremely suitable for use in making PS plates matte.

The invention of the third aspect, which is in accordance with the first or second aspect, relates to an electrostatic coating device in which the nozzle is a tubular nozzle which passes through a wall surface of the coating liquid chamber.

Because the spreading of the coating liquid at the nozzle plate can be prevented, the liquid drops can be generated stably. Thus, this electrostatic coating device has the feature that uniformity of the charged drops is particularly excellent.

The invention of the fourth aspect, which is in accordance with the first or second aspect, relates to an electrostatic coating device in which the nozzle is a nozzle hole which passes through a wall surface of the coating liquid chamber.

This electrostatic coating device has the feature that the plate-shaped member which forms the nozzle, i.e., the nozzle plate, can be fabricated particularly stably.

The invention of the fifth aspect, which is in accordance with any one of the first through fourth aspects, relates to an electrostatic coating device in which the voltage applying portion is a voltage generating device connected to at least one of the coating liquid chamber and the nozzle.

Voltage can be applied by connecting the voltage generating device to the coating liquid chamber or the nozzle. Thus, this electrostatic coating device has the feature that the voltage applying electrode does not have to be provided at the interior of the coating liquid chamber, and the structure can be simplified.

The invention of the sixth aspect, which is in accordance with any one of the first through fourth aspects, relates to an electrostatic coating device in which the voltage applying portion is a voltage applying electrode provided at the interior of the coating liquid chamber.

This electrostatic coating device has the feature that the coating liquid chamber and the nozzle can be formed of an insulative material.

The invention of the seventh aspect, which is in accordance with any one of the first through sixth aspects, relates to an electrostatic coating device in which the voltage applied by the voltage applying portion is DC voltage.

In this electrostatic coating device, a DC power source circuit in the electrostatic coating device can be used for the voltage applying portion. Thus, the electrostatic coating device has the feature that the entire device can be structured inexpensively.

The invention of the eighth aspect, which is in accordance with any one of the first through seventh aspects, relates to an electrostatic coating device in which the object-to-be-coated is in a continuous strip form.

This electrostatic coating device can make the coating liquid adhere continuously to the object-to-be-coated.

The invention of the ninth aspect, which is in accordance with any one of the first through eighth aspects, relates to an electrostatic coating device which further comprises an object-to-be-coated grounding portion grounding the object-to-be-coated at a time of coating the coating liquid onto the object-to-be-coated.

In this electrostatic coating device, the voltage of the object-to-be-coated can be made to be 0 by grounding the object-to-be-coated by the object-to-be-coated grounding portion. Thus, the charged drop of the coating liquid which flies from the nozzle moves, due to Coulomb force, toward the object-to-be-coated. Accordingly, there is no need to apply, to the object-to-be-coated, voltage of a polarity which is opposite that of the voltage applied to the coating liquid by the voltage applying portion. Thus, the structure of the electrostatic coating device can be simplified and can be made more compact.

When, for example, the object-to-be-coated is in a continuous strip form, the object-to-be-coated grounding portion may be a grounding roller, which is connected to one end of a conductor (a wire) whose other end is grounded and which rotates while contacting the object-to-be-coated, or may be the ground electrode which will be described later, or the like.

The invention of the tenth aspect, which is in accordance with the ninth aspect, relates to an electrostatic coating device in which the object-to-be-coated grounding portion is a ground electrode which, at the time of coating the coating liquid, is grounded, and is disposed one of between the object-to-be-coated and the nozzle, and adjacent to a surface of the object-to-be-coated which surface is at a side opposite a side at which the coating liquid is to adhere.

This electrostatic coating device has the feature that, because the charged particle which has been discharged from the nozzle is pulled by the ground electrode and flies toward the object-to-be-coated, the object-to-be-coated can be electrostatically coated even if formed from an insulative material.

The invention of the eleventh aspect, which is in accordance with any one of the first through tenth aspects, relates to an electrostatic coating device in which the coating liquid chamber has a coating liquid chamber pressure applying portion which applies pressure to the interior of the coating liquid chamber at a given cycle.

In this electrostatic coating device, in addition to the electrostatic force which is applied to the charged drop between the charged drop and the object-to-be-coated or the charged drop and the ground electrode, the force of the pressure applied by the coating liquid chamber pressure applying portion is also applied to the charged drop. Accordingly, this electrostatic coating device has the feature that electrostatic coating can be carried out easily even in cases in which the coating liquid has particularly high viscosity.

The invention of the twelfth aspect, which is in accordance with the eleventh aspect, relates to an electrostatic coating device in which the coating liquid chamber pressure applying portion is driven by a piezo-electric element.

The piezo-electric element does not have a mechanical driving portion. Thus, this electrostatic coating device has the feature that it is very easy to incorporate the coating liquid chamber pressure applying portion into the coating liquid chamber.

The invention of the thirteenth aspect, which is in accordance with any one of the first through twelfth aspects, relates to an electrostatic coating device in which the object-to-be-coated is electrically conductive.

This electrostatic coating device is an example in which the electrostatic coating device of the present invention is applied to the electrostatic coating of a sheet member which is formed from an electrically conductive material, such as a PS plate, a thin aluminum plate, a thin steel plate, or the like.

The invention of the fourteenth aspect, which is in accordance with any one of the first through thirteenth aspects, relates to an electrostatic coating device in which the object-to-be-coated is a PS plate, and the coating liquid is a matting liquid used in making the PS plate matte.

This electrostatic coating device is an example in which the electrostatic coating device of the present invention is applied to making a PS plate matte.

The invention of the fifteenth aspect, which is in accordance with any one of the first through fourteenth aspects, relates to an electrostatic coating device in which a diameter of the nozzle is selected appropriately in accordance with a magnitude of viscosity of the coating liquid.

This electrostatic coating device has a nozzle of a diameter which corresponds to the viscosity of the coating liquid. Thus, the electrostatic coating device has the feature that the coating liquid can efficiently be made into charged fine particles, even in cases in which, in particular, a highly-viscous coating liquid is electrostatically coated.

The invention of the sixteenth aspect, which is in accordance with any one of the first through fifteenth aspects, relates to an electrostatic coating device in which the voltage applied by the voltage applying portion is AC voltage.

This electrostatic coating device has the feature that even highly-viscous coating liquids can be electrostatically coated easily.

The invention of the seventeenth aspect, which is in accordance with the sixteenth aspect, relates to an electrostatic coating device in which a frequency of the AC voltage is 1000 Hz or more.

In accordance with this electrostatic coating device, even coating liquids whose viscosity is several 1000 mPa·s can be coated.

The invention of the eighteenth aspect relates to an electrostatic coating method comprising the steps of: applying, to a coating liquid, voltage which is one of positive and negative with respect to an object-to-be-coated onto which the coating liquid is to be coated; and expelling the coating liquid in drop form from a nozzle toward the object-to-be-coated.

In this electrostatic coating method, in accordance with the same principles as those discussed in connection with the electrostatic coating device relating to the first aspect, charged drops of the coating liquid are released at a constant interval from the nozzles toward the object-to-be-coated, and fly toward the object-to-be-coated and adhere thereto. Accordingly, the electrostatic coating method has the same advantages as those of the above-described coating device.

The invention of the nineteenth aspect of the present invention relates to an electrostatic coating device comprising: a coating liquid chamber accommodating a coating liquid in an interior of the coating liquid chamber; a tubular nozzle expelling the coating liquid accommodated in the coating liquid chamber; and a voltage applying portion applying, to the coating liquid, voltage which is one of positive and negative with respect to an object-to-be-coated onto which the coating liquid is to be coated, so as to make the coating liquid be expelled in drop form from the nozzle toward the object-to-be-coated, wherein an outside dimension of the nozzle at a distal end portion of the nozzle is 3.5 times or less an inner diameter.

In this electrostatic coating device, in the same way as in the electrostatic coating device of the first aspect, the charged drop, due to Coulomb force, flies toward the object-to-be-coated and adheres thereto. Accordingly, as compared with a device having a rotary atomizing head such as a conventional electrostatic coating device, coating liquids of even higher viscosities can be used.

Further, because the outside dimension at the distal end portion of the nozzle is formed to be 3.5 times or less the inner diameter of that, the charged drop does not excessively spread at the distal end portion of the nozzle. Accordingly, in this electrostatic coating device, even if the amount of the liquid expelled from the nozzle is large, an excessively large charged drop does not form at the distal end of the nozzle and the particle size of the charged drops does not become non-uniform. Thus, a large number of projections having a uniform configuration and diameter can be formed on the entire surface of the object-to-be-coated.

Thus, this electrostatic coating device can be suitably used for making PS plates matte.

The cross-sectional configuration of the outer peripheral surface of the nozzle is usually circular, but may be polygonal such as triangular, square, pentagonal, hexagonal, octagonal, or the like.

Accordingly, when the cross-sectional configuration of the outer peripheral surface of the nozzle is circular, the outside dimension is the outer diameter of the nozzle. When the cross-sectional configuration is polygonal, the outside dimension is the diameter of an imaginary circle which is inscribed in the cross-section of the outer peripheral surface.

In accordance with this electrostatic coating device, in the same way as with the electrostatic coating device of the first aspect, even if the coating liquid is a highly-viscous liquid, it can efficiently be made into fine particles, and charged drops having a uniform particle size distribution close to monodisperse can be obtained.

In the same way as in the electrostatic coating device of the first aspect, the coating liquid which can be coated by the electrostatic coating device is not particularly limited-provided that it can be coated onto the object-to-be-coated.

The same objects to be coated as those used in the electrostatic coating device of the first aspect can be used.

The coating liquid chamber and the nozzle may be formed of the same materials as those used in the electrostatic coating device of the first aspect.

The inner diameter of the nozzle is preferably in the range of 0.01 to 0.2 mm, and is particularly preferably within the range of 0.01 to 0.1 mm. However, any arbitrary inner diameter can be selected in accordance with the particle size of the charged drops to be expelled and the voltage applied by the voltage applying portion.

The interval between nozzles can be determined in the same way as in the electrostatic coating device of the first aspect.

The interval between the distal end of the nozzle and the object-to-be-coated can be determined in the same way as in the electrostatic coating device of the first aspect.

The nozzle may be directed downward, upward, or sideways.

When the coating liquid chamber and the nozzle are formed from an electrically conductive material, devices and circuits which are the same as those of the electrostatic coating device of the first aspect can be used as the voltage applying portion and the voltage generating device.

When the coating liquid chamber and the nozzle are formed from an insulative material, the voltage applying portion, the voltage applying electrode, and the voltage generating device may be structured in the same way as in the electrostatic coating device of the first aspect.

The inner wall surfaces of the coating liquid chamber may be lined with an electrically conductive material, and this electrically conductive lining may be used as the voltage applying electrode.

The magnitude of the voltage applied at the voltage applying portion can be determined from the relationship with the distance from the distal end of the nozzle to the object-to-be-coated, such that the number of charged drops expelled from the nozzle in one second falls within a desired range. Usually, the magnitude of the voltage is within a range of 1 to 30 kV, and preferably a range of 3 to 20 kV.

Although the voltage applying portion may apply direct current, in cases in which the viscosity of the coating liquid is particularly high, the coating liquid can efficiently be made into drops if alternating current is applied. Examples of the alternating current are, in addition to sine current, rectangular wave current, trapezoidal wave current, triangular wave current, and the like.

When alternating current is applied, the particle size of the charged drops expelled from the nozzle can be controlled by controlling the waveform of the alternating current.

When voltage is applied by the voltage applying portion, or when the object-to-be-coated is a non-conductive sheet material, the electrostatic coating device can be structured in the same way as the electrostatic coating device of the first aspect.

The invention of the twentieth aspect, which is in accordance with the nineteenth aspect, relates to an electrostatic coating device in which the outside dimension of the nozzle is 1.2 to 3.5 times the inner diameter.

In this electrostatic coating device, because the outer diameter is 1.2 times or more the inner diameter at the distal end portion of the nozzle, the thickness of the wall surface at the distal end portion of the nozzle can be sufficiently thick. Accordingly, the nozzle has excellent mechanical strength and durability.

The invention of the twenty-first aspect of the present invention relates to an electrostatic coating device comprising: a coating liquid chamber accommodating a coating liquid in an interior of the coating liquid chamber; a tubular nozzle expelling the coating liquid accommodated in the coating liquid chamber; and a voltage applying portion applying, to the coating liquid, voltage which is one of positive and negative with respect to an object-to-be-coated onto which the coating liquid is to be coated, so as to make the coating liquid be expelled in drop form from the nozzle toward the object-to-be-coated, wherein a reduced diameter portion, in which a diameter of an outer peripheral surface of the nozzle decreases toward a distal end of the nozzle, is formed at the nozzle.

In this electrostatic coating device, because hardly any spreading of the drop of liquid arises at the distal end of the nozzle, an excessively large charged drop does not form. Accordingly, in accordance with this electrostatic coating device, a large number of projections having uniform configurations and diameters an be formed on the entire surface of the object-to-be-coated. Thus, this electrostatic coating device can suitably be used for making PS plates matte.

The reduced diameter portion of the nozzle may be formed as a curved surface which is convex outwardly, or conversely, may be formed as a curved surface which is convex inwardly. However, forming the reduced diameter portion of the nozzle in a conical shape, i.e., a taper-shape, is preferable from the standpoint of ease of machining.

Other matters relating to the nozzle, as well as the coating liquid and the object-to-be-coated which can be used in the electrostatic coating device, and the coating liquid chamber and voltage applying portion provided at the electrostatic coating device, are the same as described in connection with the nineteenth aspect.

The invention of the twenty-second aspect, which is in accordance with the twenty-first aspect, relates to an electrostatic coating device in which the diameter of the reduced diameter portion decreases in a tapered manner.

The reduced diameter portion, which is formed at the outer peripheral surface of the nozzle, narrows in a taper-shape, i.e., a conical shape. Thus, this electrostatic coating device has the feature that machining of the nozzle is easy.

The invention of the twenty-third aspect, which is in accordance with the twenty-first or twenty-second aspect, relates to an electrostatic coating device in which an angle, which is formed by an inner peripheral surface of the nozzle and the reduced diameter portion at the outer peripheral surface of the nozzle, is 10° to 90°.

In this electrostatic coating device, the thickness of the wall surface at the distal end portion of the nozzle does not become too small and the mechanical strength is sufficient. Thus, fabrication and handling of the nozzle are easy.

The invention of the twenty-fourth aspect, which is in accordance with any one of the nineteenth through twenty-third aspects, relates to an electrostatic coating device in which an inner diameter of the nozzle is 0.01 to 0.2 mm.

The diameter of the matte on the PS plate is usually about 20 to 500 μm. Thus, by making the PS plate matte by using this electrostatic coating device, a matte having a diameter within the above range can easily be formed on the plate forming surface.

The invention of the twenty-fifth aspect, which is in accordance with any one of the nineteenth through twenty-fourth aspects, relates to an electrostatic coating device in which a length of the nozzle is 0.3 to 25 mm. In the electrostatic coating device of the present invention, the length of the nozzle preferably falls in this range from the standpoint of mechanical strength of the nozzle.

The invention of the twenty-sixth aspect, which is in accordance with any one of the nineteenth through twenty-fifth aspects, relates to an electrostatic coating device in which the nozzle is formed from a metal.

In this electrostatic coating device, by applying voltage to the nozzle, voltage can be applied as well to the coating liquid stored within the coating liquid chamber. Thus, the voltage applying portion can be formed by a voltage generating portion, which generates a predetermined voltage, and a conductor (a wire), which electrically connects the voltage generating portion and the nozzle.

Accordingly, this electrostatic coating device has the feature that the structure of the voltage applying portion can be simplified.

The invention of the twenty-seventh aspect, which is in accordance with any one of the nineteenth through twenty-sixth aspects, relates to an electrostatic coating device in which the nozzle is a plurality of nozzles.

This electrostatic coating device can be suitably used to adhere a coating liquid on the entire surface of an object-to-be-coated.

The invention of the twenty-eighth aspect, which is in accordance with any one of the nineteenth through twenty-seventh aspects, relates to an electrostatic coating device in which the nozzle is provided erect at a nozzle plate which is a plate-shaped member forming one portion of a wall surface of the coating liquid chamber.

In this electrostatic coating device, the coating head can be formed from a coating liquid chamber main body, which accommodates the coating liquid in the interior thereof and which has an opening portion at which the nozzle plate is fit, and a nozzle plate at which the nozzle is provided erect. Thus, it is easy to fabricate the coating head.

This electrostatic coating device has the feature that, if the nozzle plate is formed so as to be attachable to and detachable from the coating liquid chamber main body, it is easy to clean the nozzle and the periphery thereof.

An example of this electrostatic coating device is an electrostatic coating device having, at a coating liquid chamber, a nozzle plate which is a plate-shaped member in which a large number of tubular nozzles are embedded.

The invention of the twenty-ninth aspect, which is in accordance with any one of the nineteenth through twenty-eighth aspects, relates to an electrostatic coating device in which the voltage applying portion is a voltage generating device connected to at least one of the coating liquid chamber and the nozzle.

The invention of the thirtieth aspect, which is in accordance with any one of the nineteenth through twenty-eighth aspects, relates to an electrostatic coating device in which the voltage applying portion is a voltage applying electrode which is provided within the coating liquid chamber and which applies voltage to the coating liquid within the coating liquid chamber.

The invention of the thirty-first aspect, which is in accordance with any one of the nineteenth through thirtieth aspects, relates to an electrostatic coating device in which the voltage applied by the voltage applying portion is DC voltage.

This electrostatic coating device has the feature that a DC power source circuit of an electrostatic coating device which is generally used conventionally, can be used for the voltage applying portion.

The invention of the thirty-second aspect, which is in accordance with any one of the nineteenth through thirtieth aspects, relates to an electrostatic coating device in which the voltage applied by the voltage applying portion is AC voltage.

This electrostatic coating device has the feature that the liquid to be expelled can be of an even higher viscosity than in the electrostatic coating device of the thirtieth aspect.

The invention of the thirty-third aspect, which is in accordance with the thirty-second aspect, relates to an electrostatic coating device in which a frequency of the AC voltage is 500 Hz or more.

In accordance with this electrostatic coating device, even a highly-viscous liquid to be expelled can be atomized and expelled.

The invention of the thirty-fourth aspect, which is in accordance with any one of the nineteenth through thirty-third aspects, relates to an electrostatic coating device in which the object-to-be-coated is electrically conductive.

In this electrostatic coating device, voltage of a predetermined waveform is applied to the coating liquid by the voltage applying portion, and the object-to-be-coated is grounded. In this way, voltage, which is positive or negative with respect to the object-to-be-coated, can be applied to the coating liquid. Therefore, the structure can be simplified.

The invention of the thirty-fifth aspect, which is in accordance with any one of the nineteenth through thirty-fourth aspects, relates to an electrostatic coating device in which the object-to-be-coated is in a continuous strip form.

This electrostatic coating device is an example in which the electrostatic coating device of the present invention is applied to a web-shaped object-to-be-coated which is continuous in a strip form, such as a PS plate.

The invention of the thirty-sixth aspect, which is in accordance with the thirty-fourth or thirty-fifth aspect, relates to an electrostatic coating device which further comprises an object-to-be-coated grounding portion grounding the object-to-be-coated at a time of coating the coating liquid onto the object-to-be-coated.

Note that the above-described electrostatic coating devices of the twenty-seventh, twenty-ninth, thirtieth, and thirty-sixth aspects have similar structures, operations, and effects as those of the electrostatic coating devices of the second, fifth, sixth and ninth aspects, respectively.

The invention of the thirty-seventh aspect, which is in accordance with any one of the nineteenth through thirty-sixth aspects, relates to an electrostatic coating device in which the object-to-be-coated is a PS plate, and the coating liquid is a matting liquid used in making the PS plate matte.

This electrostatic coating device is an example in which the electrostatic coating device of the present invention is applied to making a PS plate matte. In accordance with this electrostatic coating device, because a highly-viscous matting liquid can be used, it is possible to form a matte having a large height-to-diameter ratio, i.e., having a configuration which is more hemispherical, on the surface of the PS plate.

The invention of the thirty-eighth aspect relates to an electrostatic coating method comprising the steps of: applying, to a coating liquid stored in a coating liquid chamber, voltage which is one of positive and negative with respect to an object-to-be-coated onto which the coating liquid is to be coated; and expelling the coating liquid in drop form toward the object-to-be-coated from a nozzle which is provided at the coating liquid chamber and whose outer diameter at a distal end portion is 3.5 times or less an inner diameter.

In accordance with this electrostatic coating method, for the same reasons as those described in connection with the electrostatic coating device of the nineteenth aspect, as compared with an electrostatic coating device having a rotary atomizing head, a highly-viscous coating liquid can be used, and hemispherical projections, whose configurations and diameters are uniform, can be formed on the surface of the object-to-be-coated.

The invention of the thirty-ninth aspect relates to an electrostatic coating method comprising the steps of: applying, to a coating liquid stored in a coating liquid chamber, voltage which is one of positive and negative with respect to an object-to-be-coated onto which the coating liquid is to be coated; and expelling the coating liquid in drop form toward the object-to-be-coated from a nozzle which is provided at the coating liquid chamber and at whose outer peripheral surface is formed a reduced diameter portion whose diameter decreases toward a distal end of the nozzle.

In accordance with this electrostatic coating method, for the same reasons as those described in connection with the electrostatic coating device of the twenty-first aspect, as compared with an electrostatic coating device having a rotary atomizing head, a highly-viscous coating liquid can be used, and hemispherical projections, whose configurations and diameters are uniform, can be formed on the surface of the object-to-be-coated.

### BRIEF DESCRIPTION OF THE DRAWINGS

FIG. 1 is a sectional view illustrating a schematic structure of a matting device which is an example of the electrostatic coating device of the present invention.

FIG. 2 is a front view of the matting device of FIG. 1, as viewed toward a nozzle plate of the matting device.

FIGS. 3A through 3C are enlarged views showing the expelling of matting liquid from a distal end of a nozzle of the matting device shown in FIG. 1.

FIG. 4 is a graph showing the relationship between L and V at the time an electrostatic drop of matting liquid is expelled, wherein L is a distance to a PS plate from the distal end of the nozzle of the matting device shown in FIG. 1, and V is voltage applied to a coating head main body by a high voltage DC power source.

FIG. 5 is a sectional view showing a schematic structure of another example of a matting device falling within the scope of the electrostatic coating device of the present invention.

FIG. 6 is a sectional view showing a schematic structure of an example of a matting device in which a voltage applying electrode is provided within a coating head.

FIG. 7 is a sectional view showing a schematic structure of another example of a matting device in which a voltage applying electrode is provided within a coating head.

FIG. 8 is a sectional view showing a schematic structure of an example of a matting device having a matting liquid chamber pressure-applying device which applies pressure at a given cycle to an interior of a matting liquid chamber.

FIGS. 9A and 9B are schematic diagrams showing a structure of an aluminum web conveying device used in Example 1, Comparative Example 1, and Comparative Example 2 (a PS plate conveying device used in Examples 2 through 9 and Comparative Example 3).

FIGS. 10A and 10B are respectively a sectional view and a front view showing a structure of an ink jet head used in Comparative Examples 1 and 2.

FIG. 11 is an enlarged view showing a structure of the distal end portion of the nozzle of the matting device shown in FIG. 1, and a structure of the periphery of the distal end portion.

FIG. 12 is a partial sectional view showing another example of a nozzle of the matting device shown in FIG. 1.

FIGS. 13A through 13D are enlarged views showing matting liquid being expelled from the distal end of the nozzle of the matting device shown in FIG. 1.

FIG. 14 is an enlarged view showing a structure of a distal end portion of a nozzle of a matting device relating to a seventh embodiment, and a structure of the periphery of the distal end portion.

FIGS. 15A and 15B are enlarged views showing a structure of a distal end portion and a structure of the periphery of the distal end portion, of another example of a nozzle of the matting device relating to the seventh embodiment.

FIGS. 16A through 16D are enlarged views showing matting liquid being expelled from the distal end of the nozzle of the matting device relating to the seventh embodiment.

### DESCRIPTION OF THE PREFERRED EMBODIMENTS

First Embodiment

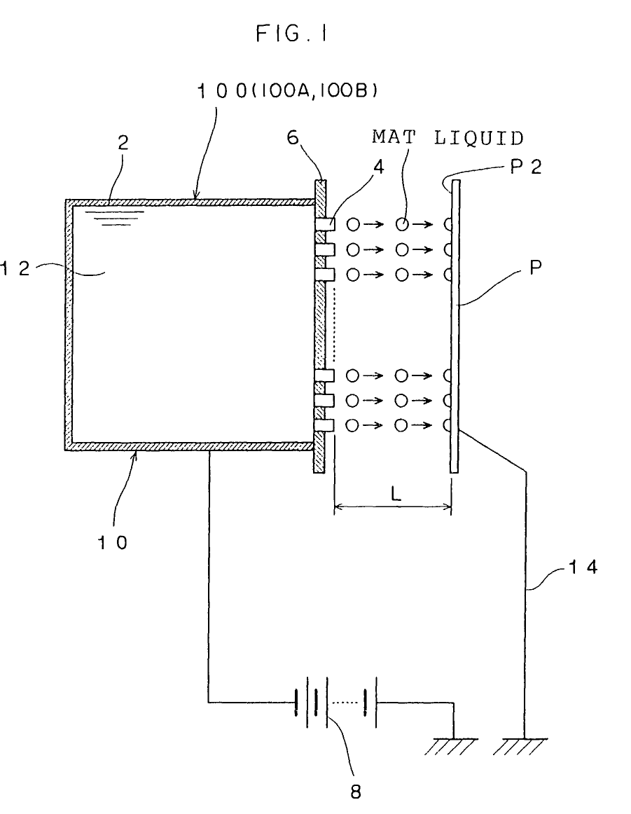

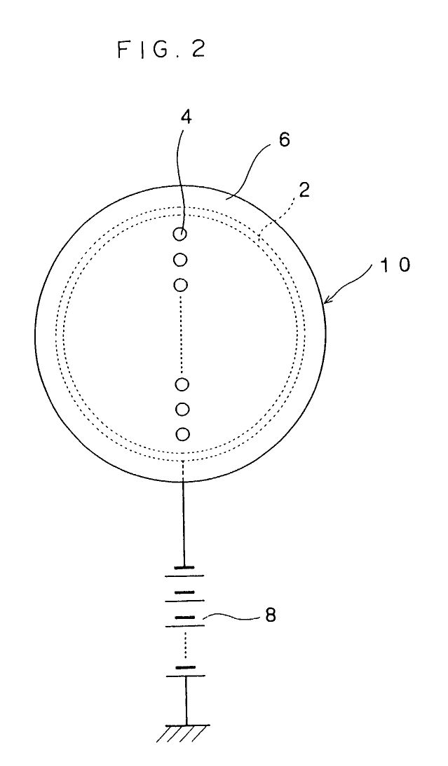

The schematic structure of a matting device which is an example of the electrostatic coating device relating to the present invention is shown in FIGS. 1 and 2. FIG. 2 shows a matting device 100 shown in FIG. 1, as seen from the front thereof.

As shown in FIGS. 1 and 2, the matting device 100 relating to the first embodiment has a coating head main body 2, a nozzle plate 6, and a high voltage DC power source 8. The coating head main body 2 is shaped as a hollow cylinder having a bottom. The nozzle plate 6 corresponds to the nozzle in the present invention, is disc-shaped, and covers the opening portion of the coating head main body 2. Tubular nozzles 4, which expel matting liquid in drops, are embedded in the nozzle plate 6 in a row along the top-bottom direction thereof. The high voltage DC power source 8 applies DC high voltage to the coating head main body 2. The high voltage DC power source 8 corresponds to the voltage generating device in the present invention. In the matting device 100, a coating head 10 is formed by the coating head main body 2 and the nozzle plate 6. A matting liquid chamber 12, which corresponds to the coating liquid chamber of the present invention and in which the matting liquid is stored, is formed at the interior of the coating head 10. Note that the matting liquid corresponds to the coating liquid in the present invention.

In the present first embodiment, the negative electrode of the high voltage DC power source 8 is connected to the coating head main body 2, and the positive electrode is grounded. Thus, a negative DC high voltage is applied to the coating head 10. However, a positive DC high voltage may be applied to the coating head 10 by connecting the positive electrode of the high voltage DC power source 8 to some portion of the coating head 10 and grounding the negative electrode.

At the time of matting a PS plate P, the PS plate P is disposed such that a plate forming surface P2 thereof, which is the surface at the side at which the photosensitive layer is formed, opposes the distal ends of the nozzles 4. In the example shown in FIG. 1, the PS plate P is in the form of a sheet which has been cut to a predetermined size. However, the PS plate P may be in a continuous strip form, i.e., may be in a web form. When the PS plate P is in the form of a sheet, as shown in FIG. 1, the PS plate is fixed so as to oppose the nozzles 4. However, when the PS plate P is in a web form, it is preferable for the PS plate P to be conveyed at a constant speed in a direction orthogonal to the direction in which the nozzles 4 are aligned at the nozzle plate 6, i.e., in the direction projecting from the surface of the drawing of FIG. 1 or the direction opposite thereto.

Because the PS plate P is sheet-shaped as mentioned above, as shown in FIG. 1, a lead wire 14, one end of which is grounded, is connected to the PS plate P. If the PS plate P is in the form of a web, it suffices to provide an electrically conductive roller, which rotates while abutting the PS plate P, at a conveying device which conveys the PS plate P, and to ground this electrically conductive roller.

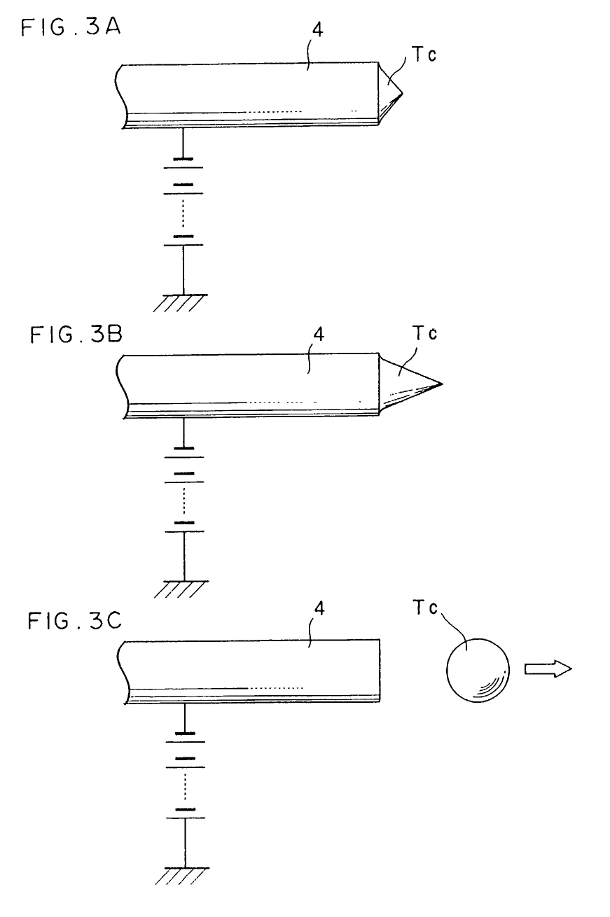

The expelling of the matting liquid from the distal end of the nozzle 4 is shown in FIGS. 3A-3C.

The nozzle 4 is electrically connected to the nozzle plate 6 and the coating head main body 2. Thus, a voltage, which is of the same magnitude as the voltage applied to the coating head main body 2 from the negative electrode of the high voltage DC power source 8, is applied to the nozzle 4. Accordingly, an electric field is generated in a vicinity of the distal end portion of the nozzle 4. As shown in FIG. 3A, at the distal end of the nozzle 4, the matting liquid forms a conical meniscus Tc, which is called a Taylor cone, due to the electric field. As shown in FIG. 3B, the meniscus Tc of the matting liquid is drawn out long and thin by the electric field from the distal end of the nozzle 4 toward the PS plate P. As shown in FIG. 3C, the meniscus Tc becomes a charged drop, which is spherical and carries a negative charge, and flies toward the PS plate P.

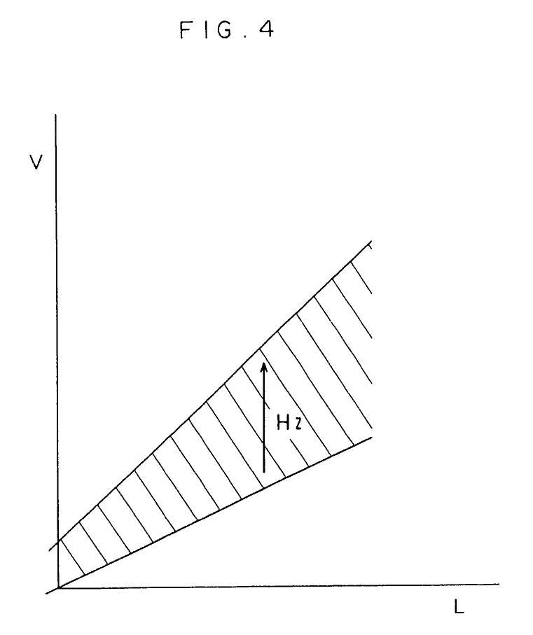

FIG. 4 shows the relationship between L and V at the time a charged drop of matting liquid is expelled from the nozzle 4, wherein L is a distance to the PS plate from the distal end of the nozzle 4, and V is the absolute value of the voltage applied to a coating head main body 2 by the high voltage DC power source 8.

The hatched region in FIG. 4 is the range of L and V when a charged drop of the matting liquid is expelled from the nozzle 4. Within this range, the greater the absolute value of the voltage V, the higher the atomization frequency Hz, which is the number of charged drops of the matting liquid which are expelled in one second. However, when the absolute value of the voltage V becomes larger than the hatched region in FIG. 4, there are cases in which the diameters of the charged drops expelled from the nozzles 4 become non-uniform. Thus, it is preferable that the voltage V have an absolute value within the range shown in FIG. 4.

In the matting device 100 relating to the present first embodiment, the charged drops of matting liquid expelled from the nozzles 4 have high uniformity of particle size, and have a particle size distribution which is extremely near to monodisperse. Further, in accordance with the matting device 100, the matting liquid, which is highly viscous, can be expelled.

Accordingly, in accordance with the matting device 100, a matte, whose diameter and height are uniform and whose height is large as compared with its diameter, can be formed on the plate forming surface P2 of the PS plate P.

Second Embodiment

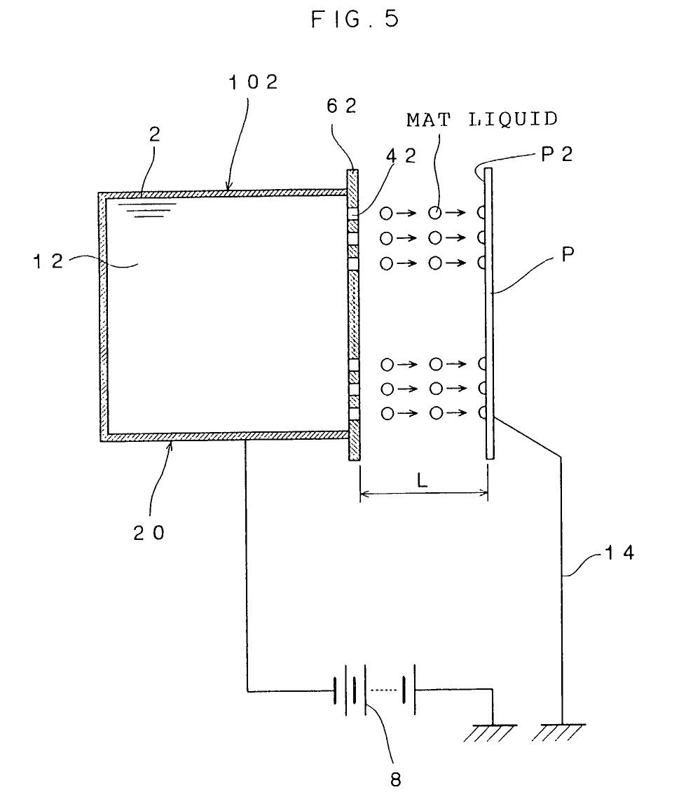

The schematic structure of another example of a matting device which is encompassed by the electrostatic coating device of the present invention, is shown in FIG. 5. In FIG. 5, reference numerals which are the same as those of FIGS. 1 through 3C denote elements which are the same as the elements denoted by these reference numerals in FIGS. 1 through 3C.

As shown in FIG. 5, a matting device 102 relating to the present second embodiment has the same structure as that of the matting device 100 relating to the first embodiment, except that a nozzle plate 62, which is provided at a coating head 20, is a structure in which nozzle holes 42, which are through holes, are formed in a metal disc in a row along the top-bottom direction in FIG. 5.

In the matting device 102, charged drops of the matting liquid are expelled from the nozzle holes 42.

In addition to the features of the matting device 100 of the first embodiment, the matting device 102 has the feature that, because the nozzle plate 62 can be fabricated merely by forming the nozzle holes 42 in a metal disc, the nozzle plate 62 can be fabricated very inexpensively.

Third Embodiment

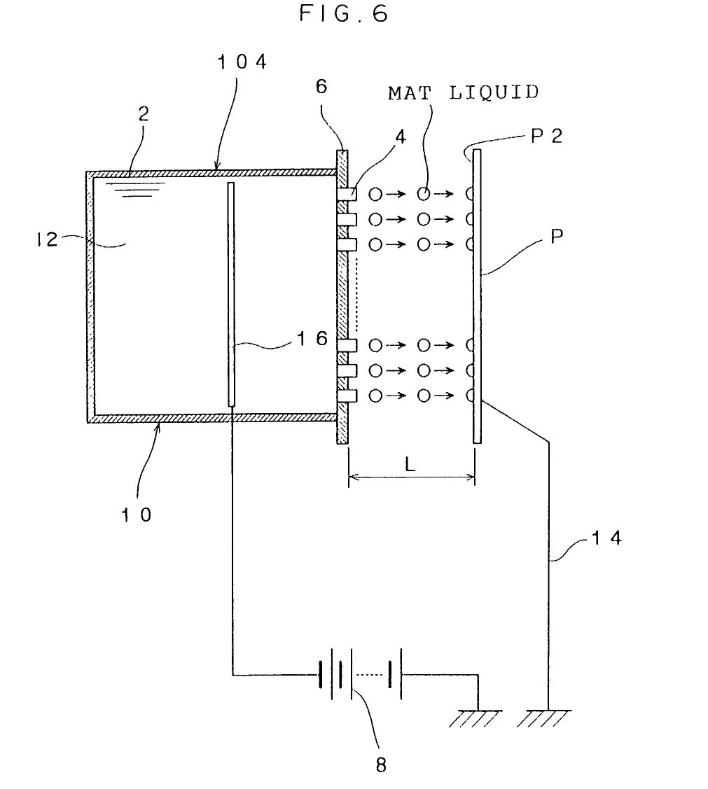

The schematic structure of an example of a matting device in which a voltage applying electrode is provided within a coating head, is shown in FIG. 6. In FIG. 6, reference numerals which are the same as those of FIGS. 1 through 3C denote elements which are the same as the elements denoted by these reference numerals in FIGS. 1 through 3C.

As shown in FIG. 6, a matting device 104 relating to the present third embodiment has the same structure as that of the matting device 100 relating to the first embodiment, except that a plate-shaped voltage applying electrode 16 is provided, parallel to the nozzle plate 6, within the coating head main body 2, and the voltage applying electrode 16 is connected to the negative electrode of the DC high voltage power source 8. Note that the voltage applying electrode 16 may be connected to the positive electrode of the DC high voltage power source 8.

A negative DC high voltage from the DC high voltage power source 8 is applied by the voltage applying electrode 16 to the matting liquid stored in the matting liquid chamber 12 in the coating head 10. Further, an electric field is generated also between the voltage applying electrode 16 and the PS plate P. Accordingly, as described in the first embodiment, at the distal end of the nozzle 4, the matting liquid forms a conical meniscus, and the meniscus is drawn out by the Coulomb force and separates from the distal end of the nozzle 4, such that a spherical charged drop is generated.

At the matting device 104, DC high voltage is applied to the matting liquid by the voltage applying electrode 16. Therefore, the matting device 104 not only has the same features as those of the matting device 100 of the first embodiment, but also, the coating head main body 2, the nozzle plate 6, and the nozzles 4 can be formed from an insulative material such as a plastic or an insulative ceramic. Accordingly, the matting device 104 is also preferable with regard to the point that the coating head main body 2, the nozzle plate 6, and the nozzles 4 can be formed integrally.

Fourth Embodiment

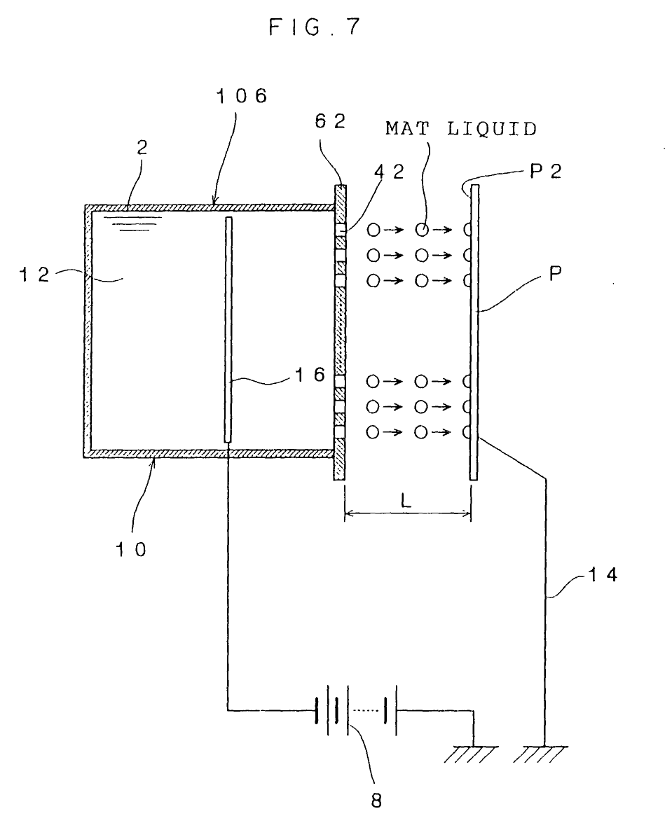

The schematic structure of another example of a matting device in which a voltage applying electrode is provided within a coating head, is shown in FIG. 7. In FIG. 7, reference numerals which are the same as those of FIGS. 1 through 3C denote elements which are the same as the elements denoted by these reference numerals in FIGS. 1 through 3C.

As shown in FIG. 7, a matting device 106 relating to the present fourth embodiment has the same structure as that of the matting device 102 relating to the second embodiment, except that the plate-shaped voltage applying electrode 16 is provided, parallel to the nozzle plate 62, within the coating head main body 2, and the voltage applying electrode 16 is connected to the negative electrode of the DC high voltage power source 8. Note that the voltage applying electrode 16 may be connected to the positive electrode of the DC high voltage power source 8.

The matting device 106 not only has the same features as those of the matting device 102 of the second embodiment, but also, the coating head main body 2 and the nozzle plate 62 can be formed from an insulative material such as a plastic or an insulative ceramic. Accordingly, the matting device 106 is also preferable with regard to the point that the coating head main body 2 and the nozzle plate 62 can be formed integrally.

Fifth Embodiment

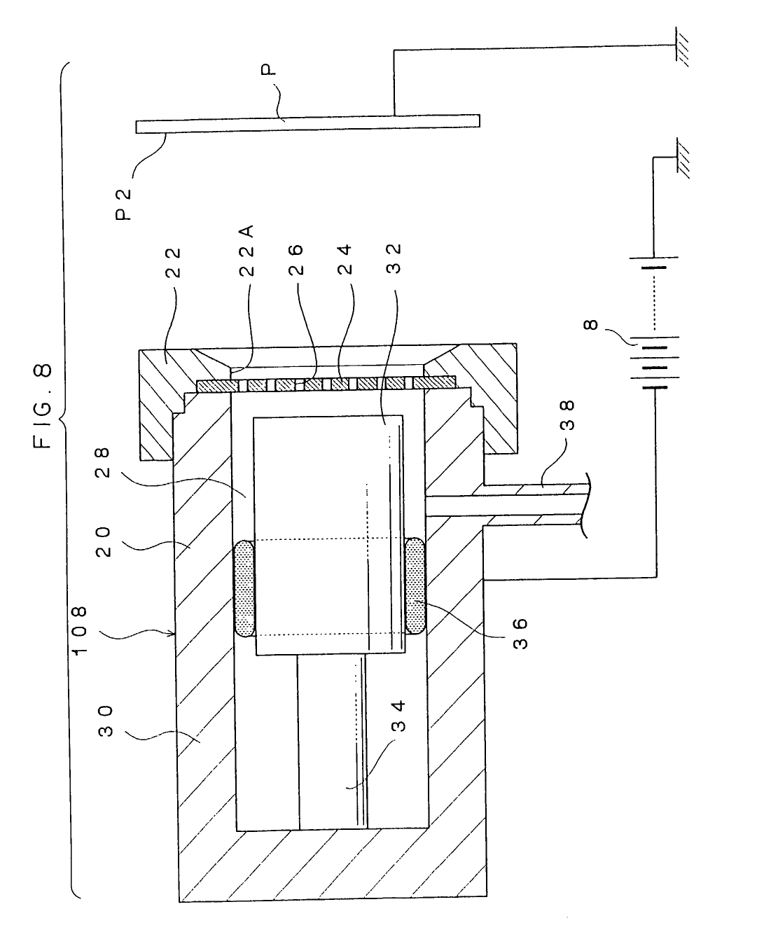

The schematic structure of an example of a matting device provided with a matting liquid chamber voltage applying device, which applies voltage at a given cycle to the interior of the matting liquid chamber, is shown in FIG. 8. In FIG. 8, reference numerals which are the same as those of FIGS. 1 through 3C denote elements which are the same as the elements denoted by these reference numerals in FIGS. 1 through 3C.

As shown in FIG. 8, a matting device 108 relating to the present fifth embodiment has a coating head main body 20 which is in the form of a hollow cylinder having a bottom, a nozzle plate 24 which is disc-shaped and covers the opening portion of the coating head main body 20, and a nozzle plate fixing cap 22 which is covered on the opening side end portion of the coating head main body 20 and fixes the nozzle plate 24. Nozzle holes 26 are formed in the nozzle plate 24 in a row along the top-bottom direction in FIG. 8. An opening portion 22A is provided in the central portion of the nozzle plate fixing cap 22 such that, when the nozzle plate 24 is attached, the portion at which the nozzle holes 26 are provided in the nozzle plate 24 is exposed. The edge portion of the opening portion 22A is chamfered at an incline toward the outer side.

A coating head 30 is formed by the coating head main body 20, the nozzle plate 24, and the nozzle plate fixing cap 22.

A cylindrical piston 32 is disposed in the space enclosed by the coating head main body 20 and the nozzle plate 24. A piezo-electric element 34, which moves the piston 32 reciprocally in the direction toward the nozzle plate 24 and the direction opposite thereto, is provided between the piston 32 and the bottom surface of the coating head main body 20. The piezo-electric element 34 is connected to a waveform generator (not shown) which applies a drive signal which extends and contracts the piezoelectric element in constant cycles toward and away from the nozzle plate 24.

A hollow cylindrical packing 36 is fit in the space between the side surface of the piston 32 and the inner side wall surface of the coating head main body 20. The hollow cylindrical packing 36 is formed from an expandable material such as silicone rubber or the like, and prevents the matting liquid from leaking from between the piston 32 and the coating head main body 20. The hollow cylindrical packing 36 also functions as a guide member which guides the piston 32 in the direction of approaching the nozzle plate 24 and the direction of moving away therefrom.

The coating head main body 20 is connected to the negative electrode of the high voltage DC power source 8, and the positive electrode of the high voltage DC power source 8 is grounded. Or, conversely, the positive electrode of the high voltage DC power source 8 may be connected to the coating head main body 20, and the negative electrode may be grounded. A matting liquid chamber 28 is formed by the piston 32, the coating head main body 20, the nozzle plate 24, and the hollow cylindrical packing 36.

Note that in FIG. 8, reference numeral 38 denotes a matting liquid supply path through which the matting liquid is supplied to the matting liquid chamber 28.

When DC high voltage V is applied to the coating head main body 20, charged drops of the matting liquid are expelled toward the PS plate P from the nozzle holes 26 at a constant cycle Hz (a constant period). The force by which the matting liquid is expelled from the nozzle holes 26 can be further strengthened by, synchronously with this cycle Hz, applying a drive signal to the piezo-electric element 34 so as to extend and contract the piezo-electric element 34, thereby driving the piston 32 so as to cyclically apply pressure to the matting liquid chamber 28.

In the matting device 108, because the force of expelling the matting liquid is particularly strong, the matting liquid, which has a particularly high viscosity, can be expelled. Accordingly, a matte, whose height is large in comparison with its diameter, can be formed by using the matting device 108 to carry out matting of a PS plate or the like by expelling the highly-viscous matting liquid.

### EXAMPLE 1

The plate forming surface of a PS plate was made matte by using the matting device 100 having the structure shown in FIG. 1.

In the matting device 100, 31 of the tubular nozzles 4, which had an inner diameter of 50 μm and a length of 1000 μm, were embedded in a row at intervals of 1000 μm in a stainless steel disc having a diameter of 70 mm, so as to fabricate the nozzle plate 6. This nozzle plate 6 was fixed to the opening portion of the coating head main body 2 which was a hollow cylinder, had a bottom, and had an inner diameter of 60 mm, so as to fabricate the coating head 10.

The positive electrode of the DC high voltage power source 8 was connected to the coating head main body 2. The negative electrode of the DC high voltage power source 8 was grounded.

The coating head 10 was fixed to an aluminum web conveying device 300 which conveyed an aluminum web W which was a strip-shaped thin plate made of aluminum.

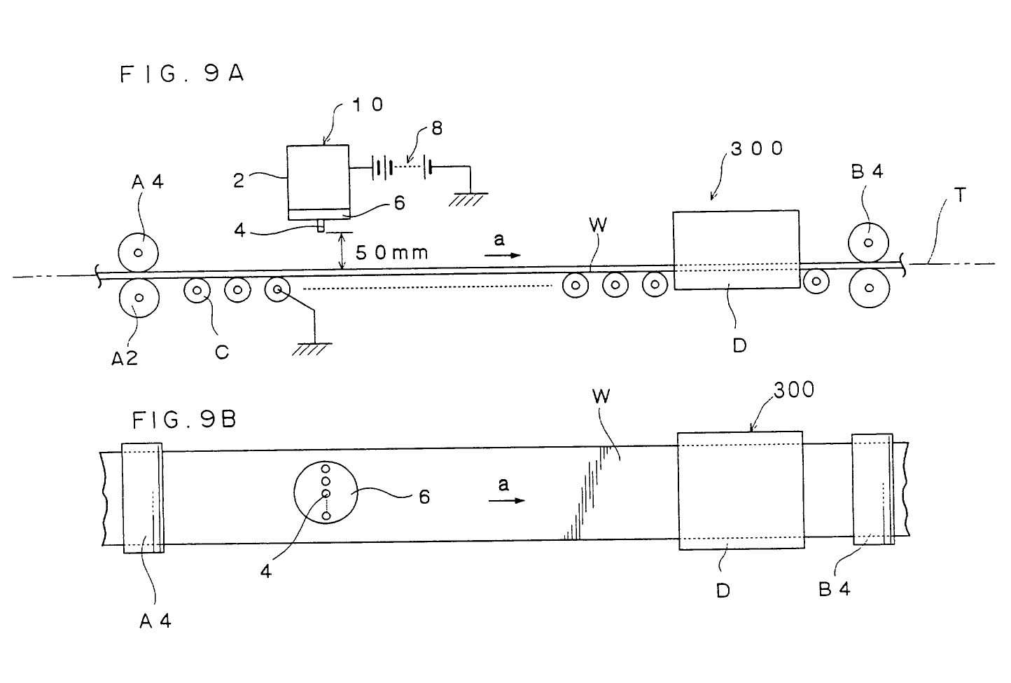

As shown in FIGS. 9A and 9B, a structure provided with the following was used as the aluminum web conveying device 300: conveying rollers A2 and A4 which are positioned at the upstream side end portion in a conveying direction a of the aluminum web W, and which convey the aluminum web W along the conveying direction a; conveying rollers B2 and B4 which are positioned at the downstream side end portion in the conveying direction a, and which work in concert with the conveying rollers A2 and A4 to convey the aluminum web W along the conveying direction a; supporting rollers C which are provided between the conveying roller A2 and the conveying roller B2 and support the aluminum web W from the underside thereof; and a hot air drying device D which is provided in a vicinity of the conveying rollers B2 and B4, and which dries the aluminum web which has been made matte by the coating head 10.

As shown in FIG. 9A, the coating head 10 was fixed between the conveying roller A4 and the hot air drying device D above a conveying plane T, which was the conveying path of the aluminum web W in the aluminum web conveying device 300, such that the opening portions of the distal ends of the nozzles 4 opposed the conveying plane T at an interval of 50 mm, and such that the direction of alignment of the nozzles 4 was orthogonal with respect to the conveying direction a of the aluminum web W.

Metal rollers which were grounded were used as the supporting rollers C.

In the aluminum web conveying device 300, the aluminum web W was conveyed at a speed of 10 m/min.

100 cc of a 25% aqueous solution of a copolymer obtained by copolymerizing methyl methacrylate/ethyl acrylate/sodium acrylate in a charged weight ratio of 68:20:12 was filled in the coating head 10 as the matting liquid. Current of +6 kV was applied by the DC high voltage power source 8. The viscosity of the aqueous solution of the matting liquid was 120 mPa·s (25° C.).

The aluminum web W was made matte over a width of 30 mm. When the aluminum web W which had been made matte was examined under a microscope, it was found that a hemispherical matte, whose size was uniform and whose height was large with respect to the diameter of the bottom surface, was formed at a uniform density. The results are shown in Table 1.

TABLE 1

| | matting liquid | | matte | | |
|---|---|---|---|---|---|
| | polymer | | | | |
| | concen- | | average | average | |
| | tration | viscosity | diameter | height | |
| | (wt %) | (mPa · s) | (μm) | (μm) | remarks |
| ex. 1 | 25 | 120 | 60 | 11 | |
| comp. ex. 1 | 25 | 120 | — | — | expul- |
| | | | | | sion |
| | | | | | was |
| | | | | | difficult |
| comp. ex. 2 | 13 | 25 | 150 | 4 | |

### COMPARATIVE EXAMPLE 1

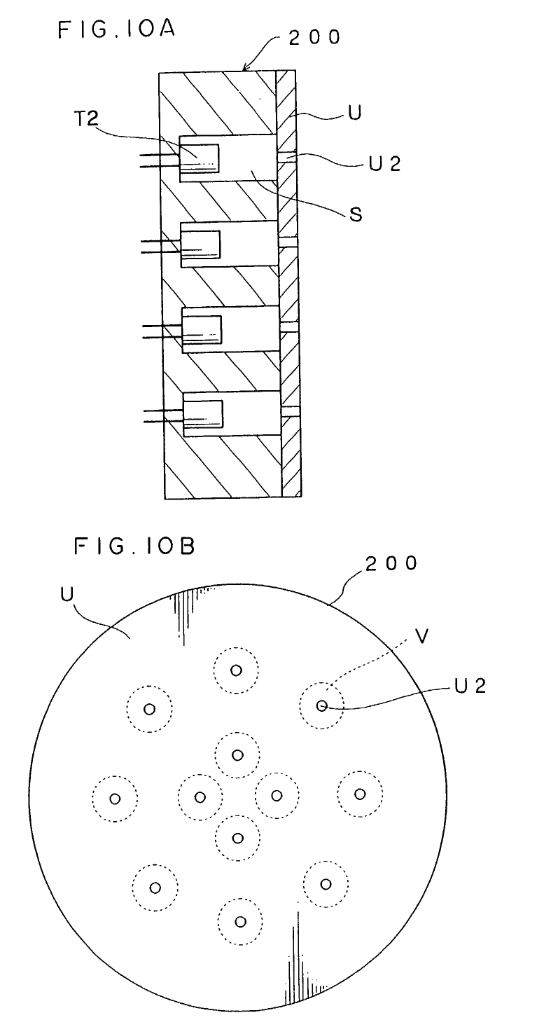

In place of the coating head 10 used in Example 1, an ink jet head 200 shown in FIGS. 10A and 10B was fixed to the aluminum web conveying device 300 illustrated in FIGS. 9A and 9B, and the processing for making the aluminum web W matte was carried out. FIG. 10A shows a cross-section, cut along the axis, of the ink jet head 200. FIG. 10B shows the front surface configuration of the ink jet head 200 when looking toward a nozzle plate U which will be described hereinafter.

As shown in FIGS. 10A and 10B, the ink jet head 200 was equipped with the nozzle plate U which was disc shaped and in which 12 nozzle holes U2 were formed; coating liquid chambers S provided so as to correspond to the respective nozzle holes U2; and piezoelectric elements T2 provided within the coating liquid chambers S and applying voltage instantaneously to the coating liquid such that the coating liquid was expelled in drop forms from the nozzle holes U2. The hole diameter of the nozzle hole U2 was 40 μm. Further, the same matting liquid as that used in Example 1 was used as the matting liquid.

The results are shown in Table 1. As shown in Table 1, it was difficult to expel the matting liquid, and it was not possible to make the aluminum web W matte.

### COMPARATIVE EXAMPLE 2

The process of making the aluminum web W matte was carried out in the same way as in Comparative Example 1, except that a 13% aqueous solution of the copolymer of Example 1 was used as the matting liquid.

The results are shown in Table 1.

Although the matting liquid could be expelled, when the drops of the matting liquid adhered to the aluminum web W, the drops spread excessively, and it was not possible to form a matte of a sufficient height.

Sixth Embodiment

The schematic structure of a matting device 10A, which is an example of the electrostatic coating device relating to the present invention, is similar to that of the matting device 100 of the first embodiment. Members which are the same as those of the matting device 100 are denoted by the same reference numerals, and description thereof is omitted.

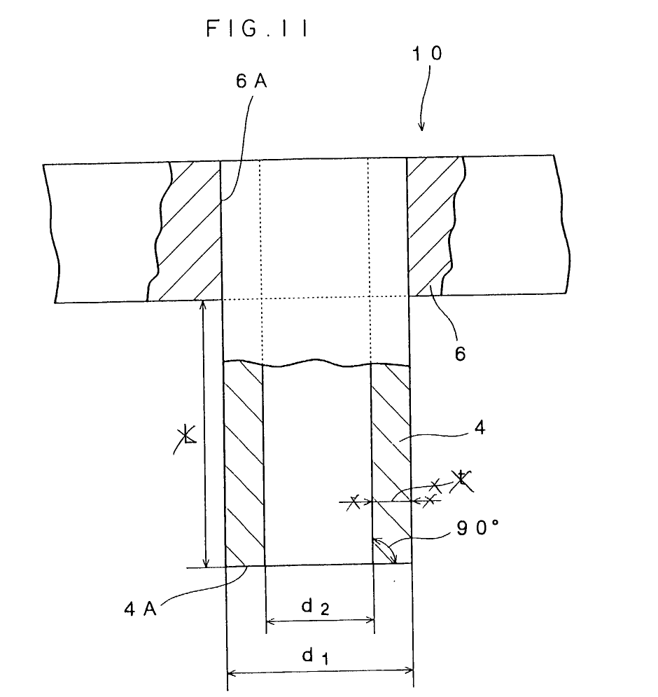

As shown in FIG. 11, a distal end surface 4A of the nozzle 4 is formed perpendicular to the axis of the nozzle 4.

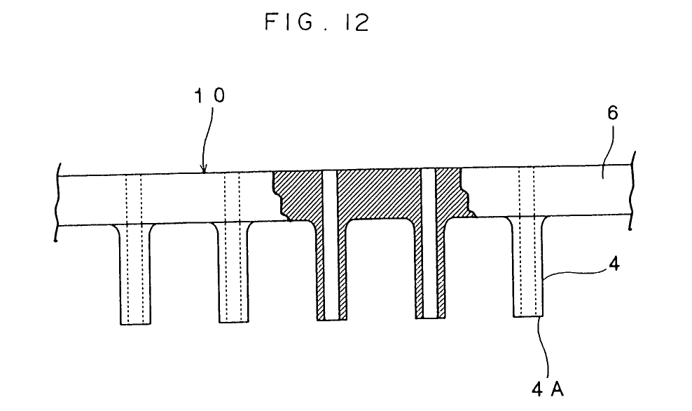

The nozzle plate 6 can be formed by, for example, forming through holes 6A, in a direction of thickness and at predetermined intervals, in a metal plate of a predetermined thickness. Further, as shown in FIG. 11, the coating head 10 can be formed by embedding the nozzles 4 in the nozzle plate 6. To embed the nozzles 4 in the nozzle plate 6, for example, the nozzles 4 may be press-fit into the through holes 6A, or the nozzles 4 may be fit into the through holes 6A and fixed therein by an appropriate means such as brazing or the like. Instead of embedding the nozzles 4 in the nozzle plate 6, the nozzles 4 may be formed integrally with the nozzle plate 6 as shown in FIG. 12. For example, a method having the following processes may be used as the method of forming the nozzles 4 and the nozzle plate 6 integrally:

(a) silicon nitride layers are formed by spattering both surfaces of a silicon wafer;

(b) aluminum layers are laminated on the silicon nitride layers, and then, the silicon wafer is penetration etched such that through holes are formed therein;

(c) silicon oxide layers are formed at the inner walls of the through holes formed in step (b); and thereafter,

(d) only the silicon nitride and the silicon at the silicon wafer are selectively etched so that the silicon wafer is reduced to a predetermined thickness and the nozzle plate 6 is formed, and simultaneously, capillaries of silicon oxide project to as to form the nozzles 4.

Forming the nozzles 4 and the nozzle plate 6 integrally is preferable in cases in which the inner diameter of the nozzle 4 is about 0.01 mm (10 μm) which is small.

An inner diameter d₂ of the nozzle 4 at the distal end surface 4A is preferably in the range of 0.01 to 0.2 mm, and is particularly preferably in the range of 0.03 to 0.1 mm. However, the inner diameter d₂ may be less than or equal to 0.01 mm or greater than or equal to 0.1 mm, depending on the particle size of the charged drop which is to be expelled and on the voltage applied by the voltage applying portion.

An outer diameter d₁ of the nozzle 4 at the distal end surface 4A is 3.5 times or less the inner diameter d₂, and is preferably 1.2 to 3.5 times the inner diameter d₂, and is particularly preferably 1.5 to 2.5 times the inner diameter d₂.

If the outer diameter d₁ is 3.5 times or less the inner diameter d₂, the drop of the coating liquid does not spread excessively at the distal end surface 4A of the nozzle 4. Thus, even in cases in which a large amount of the coating liquid is expelled from the nozzle 4, it is possible to prevent excessively large charged drops from forming, and possible to prevent the diameter of the matte from becoming non-uniform.

If the outer diameter d₁ is 1.2 times or more the inner diameter d₂, manufacturing of the nozzles 4 is easy even in cases in which the outer diameter of the nozzles 4 is small.

A distance L from the distal end surface 4A of the nozzle 4 to the PS plate P can be appropriately determined in accordance with the voltage applied at the high voltage DC power source 8 and the size of the matte which is to be formed on the surface of the PS plate P.

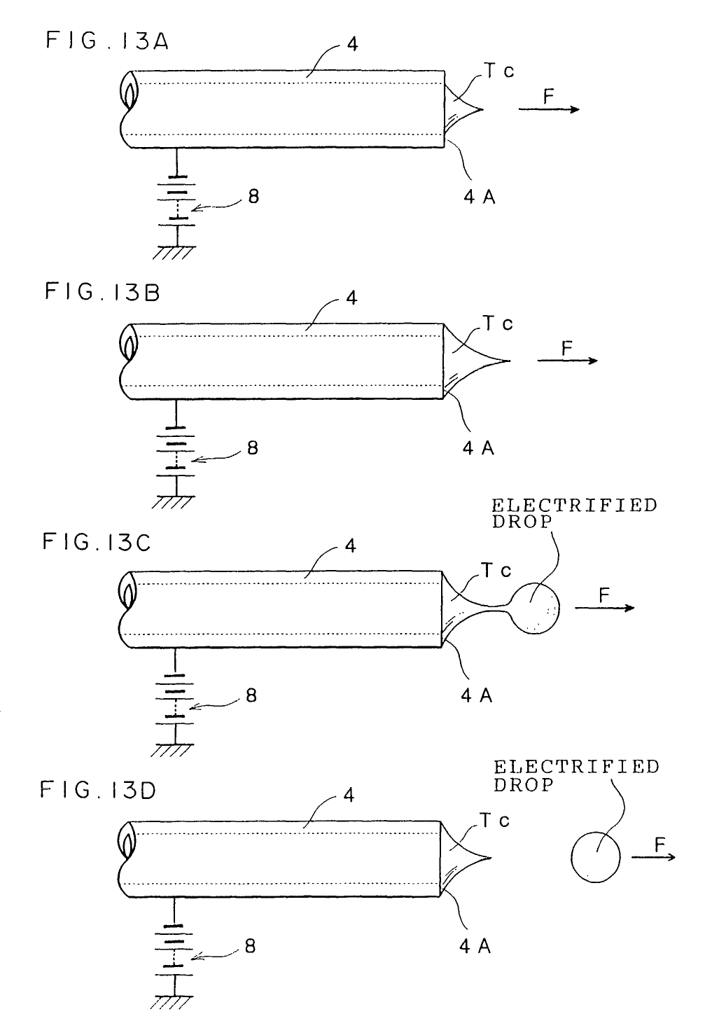

The expelling of the matting liquid from the distal end of the nozzle 4 is shown in FIGS. 13A through 13D.

Because the nozzle 4 is electrically connected to the nozzle plate 6 and the coating head main body 2, voltage, of a magnitude which is the same as the voltage applied to the coating head main body 2 from the negative electrode of the high voltage DC power source 8, is applied to the nozzle 4 as well. Accordingly, an electric field F in the direction toward the PS plate P, i.e., in the direction toward the right in FIGS. 13A through 13D, arises between the distal end portion of the nozzle 4 and the PS plate P. Accordingly, as shown in FIG. 13A, at the distal end of the nozzle 4, the matting liquid is pulled toward the right by the electric field F and forms a conical meniscus Tc called a Taylor cone.

Because the electric field F works on the meniscus Tc, as shown in FIG. 13B, the meniscus Tc is drawn out from the distal end surface 4A of the nozzle 4 toward the PS plate P, and simultaneously, spreads over and coats the entire distal end surface 4A. Thus, the diameter of the bottom surface of the meniscus Tc is equal to the diameter of the distal end surface 4A.

As shown in FIG. 13C, the meniscus Tc is further attracted toward the PS plate, and the distal end portion thereof swells into a sphere such that a charged drop is formed. Simultaneously, a neck arises between the charged drop and the meniscus Tc.

Then, as shown in FIG. 13D, the charged drop separates from the distal end of the meniscus Tc and flies toward the PS plate P.

Here, as is clear from FIG. 13C, if the diameter of the bottom surface of the meniscus Tc becomes large, the height of the meniscus Tc also becomes large, and the size of the charged drop formed at the distal end of the meniscus Tc also becomes large.

However, in the matting device 100A, as described above, the outer diameter d₁ of the nozzle 4 is 3.5 times or less the inner diameter d₂. Thus, the diameter of the bottom surface of the meniscus Tc also is 3.5 times or less the inner diameter d₂.

Accordingly, in the state shown in FIG. 13C, a charged drop having an excessively large diameter is not formed at the distal end of the meniscus Tc.

In the matting device 100A relating to the present sixth embodiment, a charged drop having an excessively large diameter is not formed at the nozzle 4. Thus, the particle size of the charged drops is uniform, and the charged drops have a particle size distribution which is extremely near to monodisperse. Moreover, even a highly-viscous matting liquid can be expelled.

Accordingly, in accordance with the matting device 10A, a matte, whose diameter and height are uniform and whose height is large as compared to its diameter, can be formed on the plate forming surface P2 of the PS plate P.

Seventh Embodiment

An example of a matting device in which a reduced diameter portion is formed at the distal end of a nozzle will be described hereinafter.

The overall structure of a matting device 100B relating to the seventh embodiment is similar to that of the matting device 100A relating to the sixth embodiment, and is the structure shown in FIGS. 1 and 2.

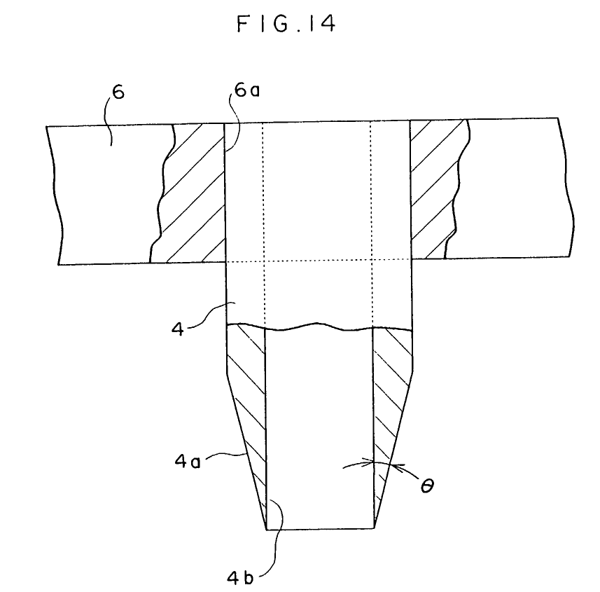

The distal end portion of the nozzle 4 of the matting device 100B and the vicinity of the distal end portion are shown in FIG. 14.

As shown in FIG. 14, the diameter of the distal end portion at an outer peripheral surface 4a of the nozzle 4 decreases, such that the distal end portion is formed in a taper shape, i.e., a conical shape. At the distal end of the nozzle 4, the outer peripheral surface 4a intersects an inner peripheral surface 4b of the nozzle 4 at an angle θ.

The angle θ is less than 90°, i.e., is acute. From the standpoint of machining, angle θ is preferably 10° or more, and is particularly preferably 30 to 75°.

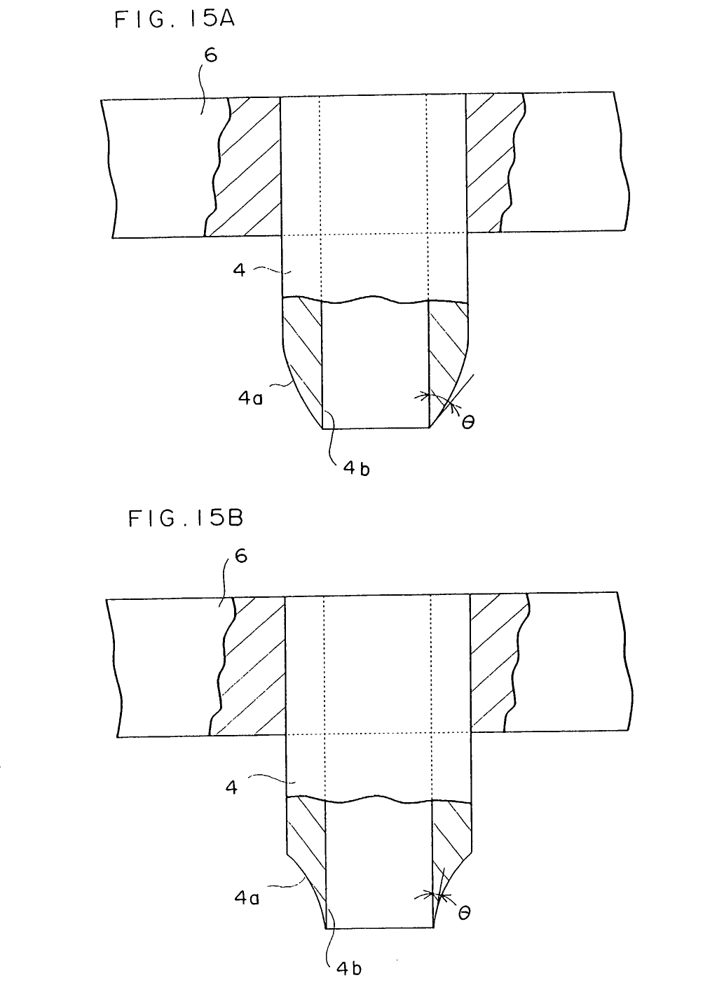

Another example of the nozzle 4 is shown in FIGS. 15A and 15B. FIG. 15A shows an example of a nozzle in which the reduced diameter portion is formed as a curved surface which is convex outwardly, and FIG. 15A shows an example of a nozzle in which the reduced diameter portion is formed as a curved surface which is convex inwardly. In both of the nozzles shown in FIGS. 15A and 15B, angle θ is the angle at which the outer peripheral surface 4a and the inner peripheral surface 4b intersect.

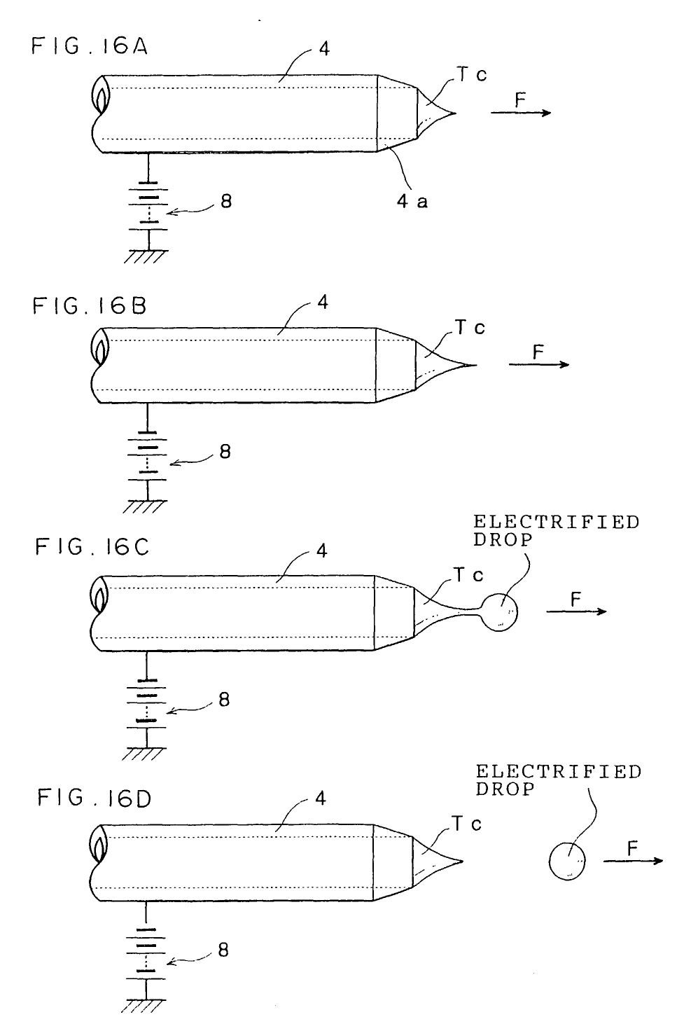

The expelling of the matting liquid from the distal end of the nozzle 4 is shown in FIGS. 16A through 16D.

In the matting device 100B as well, in the same way as the matting device 100A, as shown in FIG. 16A, at the distal end of the nozzle 4, the matting liquid is pulled toward the right by the electric field F and forms a conical meniscus Tc called a Taylor cone.

As shown in FIG. 16B, the meniscus Tc is drawn out toward the PS plate P by the electric field F.

As shown in FIG. 16C, the distal end portion of the meniscus Tc swells into a sphere such that a charged drop is formed. Simultaneously, a neck arises between the charged drop and the meniscus Tc. As shown in FIG. 16D, the charged drop separates from the distal end of the meniscus Tc and flies toward the PS plate P.

However, at the distal end of the nozzle 4, as described above, the outer peripheral surface 4a and the inner peripheral surface 4b intersect at an acute angle. Thus, a ridge is formed by the outer peripheral surface 4a and the inner peripheral surface 4b.

Accordingly, even in cases in which the amount of matting liquid expelled from the nozzle 4 is increased due to a means for increasing the voltage applied from the high voltage DC power source 8 or the like, the meniscus Tc formed at the distal end does not spread outwardly and a charged drop having an excessively large diameter is not formed. Thus, the particle size of the charged drops is very uniform. Further, even a matting liquid which is highly viscous can be expelled.

Accordingly, in accordance with the matting device 100B, a matte, whose diameter and height are uniform and whose height is large as compared to its diameter, can be formed on the plate forming surface P2 of the PS plate P.

### EXAMPLES 2 THROUGH 4, COMPARATIVE EXAMPLE 3

The plate forming surface of a PS plate was made matte by using the matting device 100A relating to the sixth embodiment.

In the matting device 100A, 31 of the tubular nozzles 4, which had at the distal ends thereof an inner diameter of 0.1 mm and an outer diameter of 0.15 to 0.40 mm, were embedded in a row at intervals of 1000 μm in a stainless steel disk having a diameter of 70 mm, so as to fabricate the nozzle plate 6. This nozzle plate 6 was fixed to the opening portion of the coating head main body 2 which was a hollow cylinder having a bottom and which had an inner diameter of 60 mm, so as to fabricate the coating head 10. The outer diameter of the nozzle 4 was as shown in Table 2.

The positive electrode of the DC high voltage power source 8 was connected to the coating head main body 2. The negative electrode of the DC high voltage power source 8 was grounded.

The coating head 10 was fixed to a PS plate conveying device which conveyed the PS plate P which was in a continuous web form.

A device similar to the aluminum web conveying device 300 shown in FIGS. 9A and 9B was used as the PS plate conveying device. Namely, a structure provided with the following was used as the PS plate conveying device: the conveying rollers A2 and A4 which are positioned at the upstream side end portion in the conveying direction a of the PS plate P (which is shown by “W” in FIGS. 9A and 9B), and which convey the PS plate P along the conveying direction a; the conveying rollers B2 and B4 which are positioned at the downstream side end portion in the conveying direction a, and which work in concert with the conveying rollers A2 and A4 to convey the PS plate P along the conveying direction a; the supporting rollers C which are provided between the conveying roller A2 and the conveying roller B2 and support the PS plate P from the underside thereof; and the hot air drying device D which is provided in a vicinity of the conveying rollers B2 and B4, and which dries the PS plate P which has been made matte by the coating head 10.

The coating head 10 was fixed between the conveying roller A2 and the hot air drying device D above the conveying plane T, which was the conveying path of the PS plate P in the PS plate conveying device, such that the opening portions of the distal ends of the nozzles 4 opposed the conveying plane T at an interval of 50 mm, and such that the direction of alignment of the nozzles 4 was orthogonal with respect to the conveying direction a of the PS plate P.

The PS plate P was conveyed at a speed of 10 m/min at the PS plate conveying device.

The PS plate P was made matte over a width of 30 mm. When the PS plate P which had been made matte was examined under a microscope, it was found that, in Examples 2 and 3, a hemispherical matte, whose size was uniform and whose height was large with respect to the diameter of the bottom surface, was formed at a uniform density. Further, it was found that, in Example 4, the matte distribution was slightly non-uniform. The results are shown in Table 2.

TABLE 2

| | | | outer | | matte | |
|---|---|---|---|---|---|---|
| | inner | | diameter/ | | con- | |
| | dia- | outer | inner | matte | figu- | |
| | meter | diameter | diameter | diameter | ration | others |
| ex. 2 | 0.10 | 0.15 mm | 1.5 | 60-80 μm | ◯ | |
| ex. 3 | mm | 0.20 mm | 2.0 | 70-100 μm | ◯ | |
| ex. 4 | | 0.30 mm | 3.0 | 60-350 μm | Δ | distri- |
| | | | | | | bution of |
| | | | | | | particle |
| | | | | | | size was |
| | | | | | | somewhat |
| | | | | | | non- |
| | | | | | | uniform |
| comp. | | 0.40 mm | 4.0 | — | X | particles |
| ex. 3 | | | | | | could not |
| | | | | | | be formed |

### EXAMPLES 5 THROUGH 9

The plate forming surface of a PS plate was made matte by using the matting device 100B relating to the seventh embodiment.

The coating head 10 was fabricated by the same processes as in Example 2, except that the nozzle shown in FIG. 14 was used. This conveying head 10 was mounted to a PS plate conveying device which was the same as that in Example 2, and the processes for making the PS plate P matte were carried out.

The relationship between the angle θ and the matte diameter when the angle θ, at which the outer peripheral surface and the inner peripheral surface at the distal end of the nozzle 4 intersected, was varied from 15° to 90° is shown in Table 3.

TABLE 3

| | inner | outer | | matte |
|---|---|---|---|---|
| | diameter | diameter | angle θ (·) | diameter |
| ex. 5 | 0.10 mm | 0.15 mm | 90 | 70-100 μm |
| ex. 6 | | | 75 | 60-80 μm |
| ex. 7 | | | 45 | 60-80 μm |
| ex. 8 | | | 30 | 60-80 μm |
| ex. 9 | | | 15 | 45-75 μm |

As can be seen from Table 3, when the angle θ is small, the matte diameter also is small.

As described above, the present invention provides an electrostatic coating device and an electrostatic coating method whose structures are simple and which can expel, in drops having good monodispersability, a highly-viscous coating liquid, so as to be able to be used suitably for matting PS plates.

What is claimed is:

1. An electrostatic coating device comprising:
a coating liquid chamber storing a coating liquid in an interior of the coating liquid chamber;
a voltage applying portion applying a voltage, which is one of positive and negative with respect to an object-to-be-coated onto which the coating liquid is to be coated, to the coating liquid in the coating liquid chamber; and
a nozzle expelling, in drop form and toward the object-to-be-coated, the coating liquid to which the voltage has been applied by the voltage applying portion.

2. The electrostatic coating device of claim 1, wherein the device has a plurality of nozzles.

3. The electrostatic coating device of claim 1, wherein the nozzle is a tubular nozzle which passes through a wall surface of the coating liquid chamber.

4. The electrostatic coating device of claim 1, wherein the nozzle is a nozzle hole which passes through a wall surface of the coating liquid chamber.

5. The electrostatic coating device of claim 1, wherein the voltage applying portion is a voltage generating device connected to at least one of the coating liquid chamber and the nozzle.

6. The electrostatic coating device of claim 1, wherein the voltage applying portion is a voltage applying electrode which is provided within the coating liquid chamber and which applies voltage to the coating liquid within the coating liquid chamber.

7. The electrostatic coating device of claim 1, wherein the voltage applied by the voltage applying portion is DC voltage.

8. The electrostatic coating device of claim 1, wherein the object-to-be-coated is in a continuous strip form.

9. The electrostatic coating device of claim 1, further comprising an object-to-be-coated grounding portion grounding the object-to-be-coated at a time of coating the coating liquid onto the object-to-be-coated.

10. The electrostatic coating device of claim 9, wherein the object-to-be-coated grounding portion is aground electrode which, at the time of coating the coating liquid, is grounded, and is disposed one of between the object-to-be-coated and the nozzle, and adjacent to a surface of the object-to-be-coated which surface is at a side opposite a side at which the coating liquid is to adhere.

11. The electrostatic coating device of claim 1, wherein the coating liquid chamber has a coating liquid chamber pressure applying portion which applies pressure to the interior of the coating liquid chamber at a given cycle.

12. The electrostatic coating device of claim 11, wherein the coating liquid chamber pressure applying portion is driven by a piezo-electric element.

13. The electrostatic coating device of claim 1, wherein the object-to-be-coated is electrically conductive.

14. The electrostatic coating device of claim 1, wherein the object-to-be-coated is a PS plate, and the coating liquid is a matting liquid used in making the PS plate matte.

15. The electrostatic coating device of claim 1, wherein a diameter of the nozzle is selected appropriately in accordance with a magnitude of viscosity of the coating liquid.

16. The electrostatic coating device of claim 1, wherein the voltage applied by the voltage applying portion is AC voltage.

17. The electrostatic coating device of claim 16, wherein a frequency of the AC voltage is 1000 Hz or more.

18. An electrostatic coating method comprising the steps of:
applying, to a coating liquid stored in a coating liquid chamber, voltage which is one of positive and negative with respect to an object-to-be-coated onto which the coating liquid is to be coated; and
expelling the coating liquid in drop form from a nozzle of the coating liquid chamber toward the object-to-be-coated.

19. An electrostatic coating device comprising:
a coating liquid chamber accommodating a coating liquid in an interior of the coating liquid chamber;
a tubular nozzle expelling the coating liquid accommodated in the coating liquid chamber; and
a voltage applying portion applying, to the coating liquid, voltage which is one of positive and negative with respect to an object-to-be-coated onto which the coating liquid is to be coated, so as to make the coating liquid be expelled in drop form from the nozzle toward the object-to-be-coated,
wherein an outside dimension of the nozzle at a distal end portion of the nozzle is 3.5 times or less an inner diameter.

20. The electrostatic coating device according to claim 19, wherein the outside dimension of the nozzle at the distal end portion of the nozzle is 1.2 to 3.5 times the inner diameter.

21. An electrostatic coating device comprising:
a coating liquid chamber accommodating a coating liquid in an interior of the coating liquid chamber;
a tubular nozzle expelling the coating liquid accommodated in the coating liquid chamber; and
a voltage applying portion applying, to the coating liquid, voltage which is one of positive and negative with respect to an object-to-be-coated onto which the coating liquid is to be coated, so as to make the coating liquid be expelled in drop form from the nozzle toward the object-to-be-coated,
wherein a reduced diameter portion, in which a diameter of an outer peripheral surface of the nozzle decreases toward a distal end of the nozzle, is formed at the nozzle.

22. The electrostatic coating device of claim 21, wherein the diameter of the reduced diameter portion decreases in a tapered manner.

23. The electrostatic coating device of claim 21, wherein an angle at which the outer peripheral surface and an inner peripheral surface at the distal end of the nozzle intersect is greater than or equal to 10° and less than 90°.

24. The electrostatic coating device of claim 19, wherein an inner diameter of the nozzle is 0.01 to 0.2 mm.

25. The electrostatic coating device of claim 19, wherein a length of the nozzle is 0.3 to 25 mm.

26. The electrostatic coating device of claim 19, wherein the nozzle is formed from a metal.

27. The electrostatic coating device of claim 19, wherein the device has a plurality of nozzles.

28. The electrostatic coating device of claim 19, wherein the nozzle is provided erect at a nozzle plate which is a plate-shaped member forming one portion of a wall surface of the coating liquid chamber.

29. The electrostatic coating device of claim 19, wherein the voltage applying portion is a voltage generating device connected to at least one of the coating liquid chamber and the nozzle.

30. The electrostatic coating device of claim 19, wherein the voltage applying portion is a voltage applying electrode which is provided within the coating liquid chamber and which applies the voltage to the coating liquid within the coating liquid chamber.

31. The electrostatic coating device of claim 19, wherein the voltage applied by the voltage applying portion is DC voltage.

32. The electrostatic coating device of claim 19, wherein the voltage applied by the voltage applying portion is AC voltage.

33. The electrostatic coating device of claim 32, wherein a frequency of the AC voltage is 500 Hz or more.

34. The electrostatic coating device of claim 19, wherein the object-to-be-coated is electrically conductive.

35. The electrostatic coating device of claim 19, wherein the object-to-be-coated is in a continuous strip form.

36. The electrostatic coating device of claim 34, further comprising an object-to-be-coated grounding portion grounding the object-to-be-coated at a time of coating the coating liquid onto the object-to-be-coated.

37. The electrostatic coating device of claim 19, wherein the object-to-be-coated is a PS plate, and the coating liquid is a matting liquid used in making the PS plate matte.

38. An electrostatic coating method comprising the steps of:
applying, to a coating liquid accommodated in a coating liquid chamber, voltage which is one of positive and negative with respect to an object-to-be-coated onto which the coating liquid is to be coated; and
expelling the coating liquid in drop form toward the object-to-be-coated from a nozzle which is provided at the coating liquid chamber and whose outer diameter at a distal end portion is 3.5 times or less an inner diameter.

39. An electrostatic coating method comprising the steps of:
applying, to a coating liquid accommodated in a coating liquid chamber, voltage which is one of positive and negative with respect to an object-to-be-coated onto which the coating liquid is to be coated; and
expelling the coating liquid in drop form toward the object-to-be-coated from a nozzle which is provided at the coating liquid chamber and at whose outer peripheral surface is formed a reduced diameter portion whose diameter decreases toward a distal end of the nozzle.
